(19) United States
(12) Patent Application Publication
(10) Pub. No.: US 2009/0246735 A1
(43) Pub. Date: Oct. 1, 2009

(54) PROCESS FOR PRODUCING COLOURED SINTERED CERAMIC BODIES, IN PARTICULAR FOR DENTAL APPLICATIONS

(76) Inventors: Dirk Rogowski, Ebersbach a. d. Fils (DE); Tanja Sprügel, Stuttgart (DE); Matthias Eschle, Kirchentellinsfurt (DE)

Correspondence Address: FULBRIGHT & JAWORSKI, LLP, 666 FIFTH AVE, NEW YORK, NY, 10103-3198, US

(21) Appl. No.: 12/377,396

(22) PCT Filed: Aug. 24, 2007
(86) PCT No.: PCT/EP2007/058802

§ 371 Date: Feb. 13, 2009

(30) Foreign Application Priority Data
Aug. 25, 2006 (DE) 10 2006 039 859.9

(51) Int. Cl. A61C 13/00; C04B 35/64; C04B 35/111

(52) U.S. Cl. 433/199.1; 264/660; 501/153

(57) ABSTRACT

Coloring materials are added in dry powder form to the material of the base composition to form a colored ceramic body.

The subject matter of the present invention is a process for producing coloured sintered ceramic bodies, in particular for dental applications.

Ceramic material is a preferred material in prosthetics on account of its biocompatibility. Al₂O₃—, ZrO₂—, Si₃N₄—, MgO-und SiAlON-ceramic materials are particularly suitable. By colouring ceramic material it is possible to produce a dental prosthesis whose colour can be adjusted to the colour of natural teeth. It is known that coloured layers can be applied to ceramic bodies in a separate process or that a porous surface layer of the ceramic body can be impregnated with a liquid preparation of the substance to be coloured and after-treated. This is a complicated process.

The object of the present invention is to produce coloured sintered ceramic bodies, in particular for dental applications, which additionally have outstanding mechanical properties and can easily be processed in the pre-sintered state as white bodies.

The object is achieved by means of a production process in which the substance or substances colouring the ceramic material are added in powder form to the ceramic base composition.

The advantage of the process lies in the fact that a sintered ceramic body is produced that is coloured through completely. It is no longer necessary to apply coloured layers to the ceramic bodies in a separate process or impregnate a porous surface layer of the ceramic body with a liquid preparation of the substance to be coloured and carry out after-treatment.

In addition to iron oxide (Fe₂O₃), other metal oxides, such as in particular CeO₂, Er₂O₃, Pr₆O₁₁, and also rare-earth elements or elements of the subgroups are also suitable as colouring substances.

The result is sintered ceramic bodies which are coloured through in a uniform manner and which can easily be processed as white bodies on account of their white density so that the final form, for example as a dental prosthesis in the form of a bridge, is already achieved in this state.

The ceramic base composition in powder form is mixed in the dry state with colouring substance or substances that are to be added in powder form and then shaped by pressing matched to the material, preferably by axial or isostatic pressing. The grain sizes of the substances to be mixed are matched to each other in such a way that the mixture becomes homogeneous and no segregation occurs. It lies within the ranges that are usual for the production of high-strength ceramic materials and are matched to the respective materials.

The pressed blanks are pre-sintered to a given white density between 2.8 g/cm³ and 3.30 g/cm³ at temperatures adjusted to the respective materials and lying between 950° C. and 1200° C. After the pre-sintering, the white bodies are processed into the final shape by turning, milling, grinding or a suitable combination of these processing methods. The three-point flexural strength of the white bodies amounts to 40 MPa to 60 MPa.

After the processing, the hard sintering or dense sintering is effected at sintering temperatures matched to the respective material compositions and lying between 1200° C. and 1900° C. If necessary, the sintering can also be effected as high-temperature isostatic pressing, HIP, or another HIP after-treatment is effected for complete dense sintering.

The possibility also exists of hard sintering or dense sintering the pressed blanks directly and of carrying out the final shaping of the sintered bodies, for example to form bridges, by hard processing with material-removing tools.

The invention is explained in greater detail with the aid of an exemplary embodiment.

A zirconium-oxide body that is coloured through is produced. The mass-preparation is first effected in the dry state. The material is composed of:

| | |
|---|---|
| Y₂O₃ | 5.15 ± 0.2 w % |
| HfO₂ | <4.0 w % |
| Al₂O₃ | 0.25 ± 0.15 w % |
| other oxides | <0.5 w % |
| Fe₂O₃ | 0.01 w % to 0.30 w % |
| ZrO₂ | completed to 100 w %. |

The quantity of Fe₂O₃ added to the base composition for colouring depends on the final colour that is required.

After dry-mixing, axial pressing and pre-sintering are effected at temperatures between 950° C. and 1200° C. The white body with a density of 2.8 g/m³ to 3.30 g/m³ is brought into its final shape by turning or milling or grinding, for example. The three-point flexural strength of the white body amounts to 40 MPa to 60 MPa. After the processing, hard sintering or dense sintering is carried out at temperatures between 1100° C. and 1900° C. The sintered body is coloured through completely.

1-10. (canceled)

11. A process for producing colored sintered ceramic bodies for dental applications comprising adding a coloring substance in a dry state in powder form to a material of a base composition of the ceramic body to be produced and homogeneously mixing with the latter in the dry state.

12. A process according to claim 11, wherein the coloring substance is at least one of a Al₂O₃-material, a ZrO₂-material, a Si₃N₄-material, a MgO— material, a SiAlON-material, a metal oxide, a rare earth element or an element of a subgroup.

13. A process according to claim 11, wherein after dry-mixing the material of the base composition with the coloring substance or substances and after compressing to form a blank, pre-sintering is effected to a white density between 2.8 g/cm³ and 3.30 g/cm³.

14. A process according to claim 11, wherein the shaped body is pre-sintered at a temperature of from 950° C. to 1200° C.

15. A process according to claim 11, wherein a final form of the sintered body is achieved by processing the white bodies that have been produced by pre-sintering and have already been colored through.

16. A process according to claim 11, wherein hard sintering or dense sintering is effected at a temperature of from 1100° C. to 1900° C.

17. A process according to claim 11, wherein the powder mixture is compressed to form a blank, and the blank is hard sintered or dense sintered, and the sintered body is shaped by hard processing with a material-removing tool.

18. A sintered body produced according to the process of claim 11.

19. A sintered body produced according to the process of claim 11 that is a dental implant.

20. A sintered body produced according to the process according to claim 11 that is a dental prosthesis.

21. The process of claim 12, wherein the metal oxide is selected from the group consisting of Fe₂O₃, CeO₂, Er₂O₃ and Pr₆O₁₁.
